(19) United States
(12) Patent Application Publication
(10) Pub. No.: US 2025/0180489 A1
(43) Pub. Date: Jun. 5, 2025

(54) METHOD AND DEVICE FOR INSPECTING HOT GLASS CONTAINERS WITH A VIEW TO IDENTIFYING DEFECTS

(71) Applicant: TIAMA, Saint-Genis-Laval (FR)

(72) Inventors: Olivier COLLE, Oullins (FR); Julien FOUILLOUX, Saint-Genis-Laval (FR); Sylvain GOURGEON, Mornant (FR)

(73) Assignee: TIAMA, Saint-Genis-Laval (FR)

(21) Appl. No.: 18/725,193

(22) PCT Filed: Dec. 26, 2022
(86) PCT No.: PCT/FR2022/052506

§ 371 Date: Jun. 28, 2024

(30) Foreign Application Priority Data
Dec. 30, 2021 (FR) FR2114685

(51) Int. Cl. G01N 21/90; B07C 5/34; G01N 21/88

(52) U.S. Cl. CPC G01N 21/90; B07C 5/3408; G01N 21/8851; G01N 2021/8854; G01N 2021/8887; G01N 2021/9063

(57) ABSTRACT

There is provided a method for inspecting still hot glass containers. The method includes, for each container, acquiring at least one transmission image of the container illuminated by a source of a light passing through the container and at least one infrared radiation image of the container. The method also includes analyzing at least one transmission image and at least one infrared radiation image and ensuring a matching of at least part of the transmission image and at least part of the infrared radiation image. The method also includes classifying the container, from at least one transmission image and at least one infrared radiation image, matched with each other, in order to identify, for a container, at least one type of defect.

### TECHNICAL FIELD

The present invention relates to the technical field of online inspection of transparent or translucent containers such as for example glass bottles, pots or vials, for their quality control in order to detect and identify possible defects that may affect these containers.

The object of the invention finds particularly advantageous applications for analyzing physical characteristics of the containers for identifying non-compliant physical characteristics corresponding to defects such as for example surface defects, such as folds or crevices, internal defects in the material such as cracks, inclusions or bubbles, or even dimensional defects in the container such as the glass distribution.

### PRIOR ART

For the manufacture of glass containers, it is known that the manufacturing method comprising the melting of the glass then its conveying to forming units is implemented by means of a manufacturing facility comprising a melting furnace, a forehearth for bringing molten glass to a forming machine generally of the type designated by IS machine. The IS forming machine comprises a distributor that forms glass drops called parisons and distributes them through conduits called “delivery conduits”, towards forming sections, at the output of which the containers have a high temperature typically comprised between 300° C. and 600° C. The containers which have just been formed by the forming machine are laid successively on an output conveyor to form a row of containers. The containers are transported in line by a conveyor in order to be conveyed successively to different treatment stations. Particularly, the formed containers are brought into an annealing furnace, which raises their temperature and then cools them in a controlled manner so that the thermal constraints created by the forming process disappear. Other glass container forming methods are known for table glassware, insulators, syringes and bulbs. For example, there are forming machines such as rotary and sequential presses, not in parallel aligned sections like the IS machines. There are also machines that transform preforms into tubes, in particular monocalcium glass tubes in order to make syringes and bulbs dedicated to pharmaceutical products.

It is known to systematically inspect all the containers exiting the annealing furnace using different inspection equipment, in particular wall inspection systems such as those described in patents EP2082216, EP2145175 or EP2856122. The transmission wall inspection technique is thus known for which a light source is disposed on one side of the conveyor and at least one camera (typically 2 to 6, 12 or 24) is disposed oppositely in order to acquire at least one image formed by the light transmitted through the walls of the container. According to patent EP 1 109 008, a method for analyzing images of containers for cold inspection is described. A segmentation step detects features in the images and regions around the features. Discriminant parameters of a region are calculated and combined with a fuzzy logic method to determine the most likely type of features among a list of features corresponding to possible defects. The compliance of the region is then decided, by applying different criteria depending on the type of the retained feature. For example, a fold type defect will be ejected for a certain surface while an inclusion type defect will be rejected even if it has a small surface. This patent teaches in particular that the defects do not all have the same criticality, which justifies seeking to determine their nature before deciding to reject a container.

Generally, it appears beneficial to identify a defect as early as possible in the glass container manufacturing process so that it can be corrected as early as possible at the manufacturing facility. It is thus advantageous to detect in particular defects in the containers which are directly related to settings in the forming method, in order to correct, in case of drift, the forming method as quickly as possible, although this remains complex due to the non-linearity of the system, to the number of parameters of the method, and although a cause produces several combined effects and although several causes explain the same effect.

This is the reason why the prior art has proposed methods for observing still hot containers traveling on the output conveyor of the forming machine, with devices similar to those used under cold conditions for the inspection after the annealing lehr. According for example to the patents EP 0 177 004 and EP 3 516 377, the inspection of the walls is carried out using the same methods as the cold inspection, and these patents describe particularly means for adapting the inspection to the particular environment of the hot sector, by an arrangement of the means for managing the high surrounding temperature. Thus, a light source located on one side of the trajectory of the containers on the output conveyor of the forming machine illuminates the containers and at least one camera sensitive to the emitted light, acquires at least one transmission image of each container. The images are analyzed in order to determine which containers have a defect.

U.S. Pat. No. 6,584,805 also describes a facility for observing the still hot containers as they travel on the output conveyor of the forming machine. This facility includes an inspection station including light sources disposed on one side of the conveyor to illuminate the containers. This inspection station also includes cameras disposed on the other side of the conveyor to acquire transmission images of the containers illuminated by the light sources. This inspection station particularly makes it possible to measure the diameter of the containers at different heights of the containers. These measured diameters are compared with reference diameters in order to determine whether the containers are defective or not.

Since the hot containers emit infrared radiation, the prior art has also proposed methods for observing the hot containers traveling on the output conveyor, by an infrared camera based on the principle that the thick regions of the containers radiate more. Patent EP 0 643 297 describes a device for making an analysis and diagnosis on a method for manufacturing glass products including a sensor sensitive to the infrared radiation emitted by the objects exiting the forming machine. This system also includes a digital processing device comparing the radiation with a mathematical reference model in order to determine the existing deviations in the distribution of the glass and/or the causes leading to the presence of thermal stresses in the container.

Patent EP0 679 883 describes a device for acquiring images by an infrared camera, which collects the radiation emitted by the hot containers at the output of the manufacturing machine. The infrared camera is synchronized with the operation of the container forming cavities. For the inspection, processing software divides the container image captured by the infrared camera into inspection regions. By segmenting and measuring light or dark points located in these regions, it is possible to identify trapezoid defects and inclusions.

According to patent DE10030649 knowing the speed of the output conveyor and the order in which the containers exit the different sections, it is possible and advantageous to connect the detected defects to the original cavity in order to be able to act judiciously on the manufacturing method to correct the defects.

The prior art therefore teaches to inspect the still hot containers as soon as possible in order to quickly set or correct the forming method. Dimensional controls of diameters or heights are carried out through vision and even according to patent application WO2021009456, the thickness of glass can be measured by infrared imaging in at least two particular wavelength ranges. A dimension deviation is an identified height, diameter, inclination or thickness defect per se, and can be assigned to at least one cause of drift of the manufacturing method.

Patent U.S. Pat. No. 6,188,079 proposes to measure the glass thickness of a container based on the infrared radiation consisting in measuring a first intensity of said radiation in a first spectral band at which the radiation is emitted by the material between the two outer and inner surfaces of the container. The first spectral band whose signal depends on both the glass temperature and the thickness is preferably between 0.4 and 1.1 microns. The method also consists in measuring a second intensity of said radiation in a second spectral band at which the radiation is emitted substantially entirely by a single outer surface of the container. According to this patent, the second spectral band at which the radiation depends only on the temperature, corresponding to surface radiation, is preferably between 4.8 and 5 microns. The method consists in determining the thickness of the container between the outer and inner surfaces as a combined function of said first and second measured intensities. In other words, the thickness and the temperature are determined from the two radiation measurements taken in the first spectral band and in the second spectral band.

The situation is different concerning what will be referred to as “appearance defects”, namely the visual defects of all types: inclusions (of foreign bodies such as ceramics, metal), bubbles, folds, rivers (surface grooves), glazes (cracks), fins, trapezoids, grease stains, very thin areas, unmelted particles. These appearance defects appear in the images as local optical variations, or pixels having deviations from the background. These appearance defects can be critical if they lead to a risk for the consumer, a risk of breakage or loss of functionality of the container. However, the recognition of an appearance defect based on an image can be ambiguous. It follows, due to the safety margins implemented during detection, that containers are considered defective even though these containers are compliant.

Moreover, it should be noted that in the images, acceptable artifacts can be distinguished such as for example engravings or decorations, faintly marked mold joints. Also, there appears the need to identify exactly the nature of the appearance defects in order to identify the critical defects by distinguishing them from the other defects. Preventing the critical defects requires improving the reliability of classification of the appearance defects. In addition to the fact that improving the identification of the defects improves the efficiency of the production, this identification of the defects makes it possible to determine their potential causes so that the manufacturing facility can be driven according to the category of the detected defects. Indeed, without reliable identification of the detected defects, no safe decision to correct the manufacturing method can be taken, whether manually or automatically.

### DISCLOSURE OF THE INVENTION

The present invention aims to overcome the drawbacks of the prior art by proposing a method for controlling the quality of the hot glass containers, designed to perform more effective detection of the defects, particularly of appearances, while ensuring their safe and certain identification to provide more complete information on the corrections to be made to the control parameters of a method for manufacturing glass containers by a manufacturing facility.

The object of the invention relates to a method for inspecting still hot glass containers exiting a manufacturing facility, for identifying, for a container, a type of defects, the method consisting for each container:
in acquiring at least one transmission image of the container illuminated by a source of light passing through the container and at least one infrared radiation image of the container,
in analyzing at least one transmission image and at least one infrared radiation image,
in ensuring a matching of at least part of the transmission image and at least part of the infrared radiation image,
in classifying the container, from at least one transmission image and at least one infrared radiation image, matched with each other, in order to identify for a container, at least one type of defects.

According to one advantageous characteristic of embodiment, the container is illuminated by a light source whose emission spectrum is in a wavelength range less than 0.8 μm, and the infrared radiation image of a container in a wavelength range greater than 0.8 μm is acquired.

For example, the infrared radiation image of a container is acquired when the light source is turned off.

According to another example of implementation, the infrared radiation image is acquired in a direction of observation such that the light emitted by the light source is not captured with the infrared radiation of the container.

According to one characteristic of the invention, to ensure the matching of the transmission images and the infrared radiation images, the method detects candidate regions in the transmission images and in the infrared radiation images, the method ensuring, for each container:
a matching of the candidate regions of the transmission images or the candidate regions of the infrared radiation images with the corresponding regions respectively of the infrared radiation images and the transmission images, as a function of their position on the container,
or a matching of the candidate regions of the transmission images with the candidate regions of the infrared radiation images.

According to one variant of embodiment, the method ensures, as a matching, a fusion of the transmission images and the infrared radiation images to obtain a composite image, the method ensuring:
an extraction of classification characteristics from the composite image, expressing classification criteria in transmission and in radiation,
and a classification of the container using the classification criteria in transmission and in radiation.

According to another variant of embodiment, the method ensures, as a matching, a fusion of the transmission images and the infrared radiation images to obtain a composite image, the method ensuring:
a segmentation of the composite images to detect composite candidate regions,
an extraction of classification characteristics from the composite candidate regions, expressing classification criteria in transmission and in radiation,
a classification of the container using the classification criteria in transmission and in radiation of the composite candidate regions.

According to one characteristic of the invention:
classification criteria in transmission are extracted from the transmission images,
classification criteria in radiation are extracted from the infrared radiation images,
the container is classified using the classification criteria in transmission and in radiation.

Advantageously, classification criteria in radiation are chosen for the infrared radiation images and classification criteria in transmission are chosen for the transmission images, and/or composite criteria which take into account characteristics combining in a logical or mathematical manner transmission images and infrared radiation images are chosen, these classification criteria in radiation and in transmission being position, size, shape or photometry criteria.

Advantageously, the method consists in classifying the container by a supervised learning classifier whose input data are:
the classification criteria in radiation and in transmission,
or the radiation images and the transmission images,
or parts of the images in radiation and parts of the transmission images.

According to one exemplary implementation, the method consists in classifying the container by a supervised learning classifier whose input data are at least one composite image obtained by fusion of at least one radiation image with at least one transmission image of a container or by fusion of regions of at least one image in radiation with corresponding regions of at least one transmission image.

According to another exemplary implementation, the method consists in classifying the container by a supervised learning classifier trained by a learning database consisting of a set of records each including for an observed exemplary container:
at least one radiation image of the container, at least one transmission image of the container and at least one label assigning to the exemplary container at least one class of objects among a list of possible classes such as types of defects, or
at least one radiation image region of the exemplary container, at least one image region in transmission of the exemplary container and at least one label assigning to the corresponding region of the exemplary container at least one class of objects among a list of possible classes such as types of defects.

According to one advantageous characteristic of the invention, the method aims to classify each container according to at least one class of objects among a list of possible classes containing at least types of defects, the list of possible classes including at least: no defect, trapezoid, inclusion, bubble.

According to one advantageous characteristic of the method, a step of taking into account at least one type of detected defect is implemented to deduce adjustment information for at least one control parameter of the manufacturing facility.

Another object of the invention is to propose a device for inspecting still hot glass containers exiting a manufacturing facility for identifying, for a container, a type of defects, the device including:
a system for acquiring transmission images of the containers and infrared radiation images of the containers,
an information processing unit connected to the image acquisition system, this information processing unit being configured to include:
a system for analyzing at least one transmission image and at least one infrared radiation image of the container,
a system for matching at least one region of an transmission image and at least one region of at least one infrared radiation image of the container,
a classifier of the container, based on at least one region of at least one transmission image and at least one region of at least one infrared radiation image, matched with each other, in order to identify for a container, at least one type of defects.

According to one exemplary embodiment, the system for acquiring transmission images of the containers and infrared radiation images of the containers includes, on the one hand, a camera sensitive to the infrared radiation emitted by the containers and provided with a lens and on the other hand, a source of light passing through the containers and a camera sensitive to the light transmitted by the containers and provided with a lens.

Advantageously, the image acquisition system includes a system for selecting the light emitted by the light source and positioned to eliminate, from the radiation captured by the camera sensitive to the infrared radiation, the light emitted by the light source.

For example, the system for acquiring transmission images of the containers and infrared radiation images of the containers includes:
a light source illuminating the containers,
a sensor sensitive to the infrared radiation emitted by the containers,
a sensor sensitive to the light emitted by the light source and transmitted by the containers,
a common optical lens for recovering the infrared radiation emitted by the containers and the light transmitted by the containers, this optical lens being associated with an optical separation and filtration system to eliminate the light emitted by the light source, from the radiation received by the sensor sensitive to the infrared radiation.

According to one characteristic of implementation, the information processing unit is connected:
to an ejector for controlling the ejection of containers identified as defective, and/or
a display unit for presenting to an operator the identified defects, the transmission images and the infrared radiation images of the containers.

Typically, the information processing unit is connected to a production ECU supervising the manufacturing facility in order to:
receive from the production ECU, time information allowing the containers, their images and their detected defects to be associated with the mold number or with the forming cavity,
transmit to the production ECU the defects identified and measurements performed, so that the production ECU can automatically deduce adjustment information for at least one control parameter of the manufacturing facility.

### BRIEF DESCRIPTION OF THE DRAWINGS

FIG. 1 is a simplified view of a device according to the invention making it possible to inspect the still hot glass containers exiting an exemplary manufacturing facility.

FIG. 2 represents one exemplary embodiment of an image acquisition system for the containers exiting a manufacturing facility and implemented in the inspection device according to the invention.

FIG. 3 represents another exemplary embodiment of an image acquisition system for the containers exiting a manufacturing facility and implemented in the inspection device according to the invention.

FIG. 4 is a simplified functional block diagram of a first exemplary embodiment of the inspection device according to the invention, implementing a processing called conventional processing, of the information contained in the transmission images and in the infrared radiation images.

FIG. 5 is a simplified functional block diagram of a first exemplary embodiment of the inspection device according to the invention, implementing a segmentation operation on a composite image obtained by the matching of an transmission image and an infrared radiation image.

FIG. 6 is a simplified functional block diagram of a first exemplary embodiment of the inspection device according to the invention, implementing a Convolutional Neural Network having as input data, candidate regions matched with each other and resulting from operations of segmentation of an transmission image and an infrared radiation image.

FIG. 7 is a simplified functional block diagram of a first exemplary embodiment of the inspection device according to the invention, implementing two Convolutional Neural Networks having as input data, a candidate region resulting from an operation of segmentation of an transmission image or an infrared radiation image.

FIG. 8 is a simplified functional block diagram of a second exemplary embodiment of the inspection device according to the invention, implementing a Convolutional Neural Network having as input data, a composite image of an transmission image and an infrared radiation image.

FIG. 9 is a simplified functional block diagram of a second exemplary embodiment of the inspection device according to the invention, implementing Convolutional Neural Networks having as input data, all or part of an transmission image and an infrared radiation image, without prior segmentation.

FIG. 10A is a simulated transmission image showing a defect while FIG. 10B and FIG. 10C are simulated infrared images representing the same defect if it is respectively a filled cavity or if it is stuck glass.

FIG. 11A is an transmission image showing a defect while FIG. 11B and FIG. 11C are simulated infrared images representing the same defect if it is respectively a piece of glass or if it is a grease stain.

FIG. 12A is an infrared image while FIG. 12B is an transmission image showing an example of possible confusion between stone and blister defects.

FIG. 13A is an infrared image while FIG. 13B is an transmission image showing another example of possible confusion between small blister and stone defects.

FIG. 14A is an infrared image while FIG. 14B is an transmission image showing another example of possible confusion between blister and stone defects.

### DESCRIPTION OF THE EMBODIMENTS

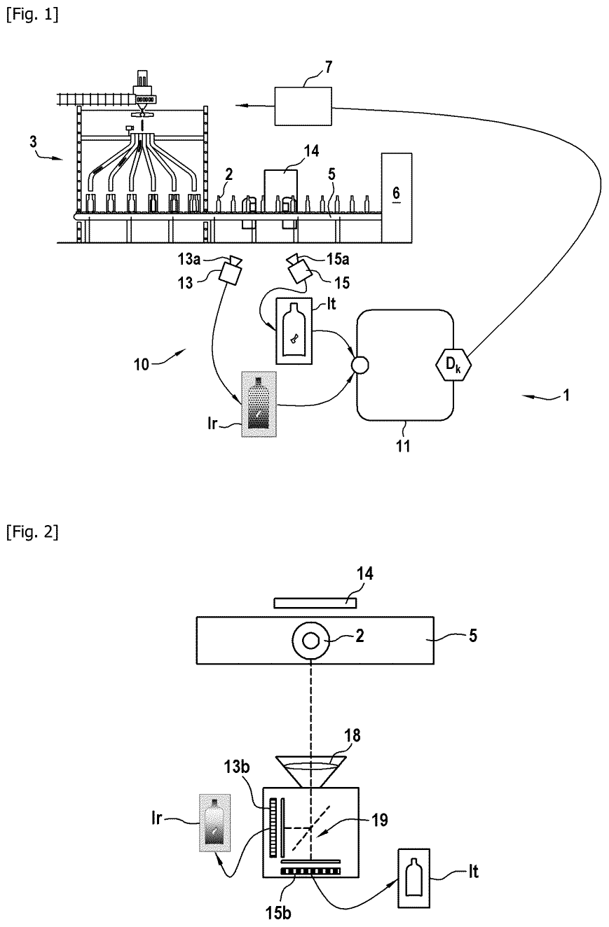

FIG. 1 illustrates a device 1 according to the invention for inspecting still hot glass containers 2 exiting a manufacturing or forming facility 3 of all types known per se. The inspection device 1 aims to detect, for each container, whether the container has a defect and to identify, for a container having a defect, a type of defect among a family of defects.

At the output of the manufacturing facility 3, the containers 2 such as in the example illustrated, glass bottles or vials, have a high temperature typically comprised between 300° C. and 600° C. In known manner, the containers 2 that have just been formed by the facility 3 are handled by an output conveyor 5 to form a row of containers by being, in the example illustrated, laid successively on the output conveyor. The containers 2 are transported in line by the conveyor 5 along a direction of transfer in order to be conveyed successively to different treating stations and particularly an annealing lehr, upstream of which is placed a coating hood 6 generally constituting the first of the treating stations after forming. Advantageously, the inspection device 1 according to the invention inspects the still hot containers upstream of the first surface treating station, namely the coating hood 6.

The manufacturing facility 3 is known per se and an example will be described succinctly to only allow an understanding of the interaction between the inspection device 1 according to the invention and the manufacturing facility 3.

The manufacturing facility 3 includes a production ECU 7 for supervising the different functionalities of the forming facility 3. Conventionally, the manufacturing facility 3 includes several distinct forming sections operating in parallel and successively delivering at least one glass container. In the example of the IS machine, the different distinct forming sections each include at least one blank mold receiving a glass parison and at least one blow mold. In a known manner, it is possible to identify the forming section, the blank mold and the blow mold from which each container 2 comes, the order of travel of the containers being known for a given production.

The inspection system 1 according to the invention includes a system 10 for acquiring transmission images It of the containers 2 and infrared radiation images Ir of the containers 2 and an electronic information processing unit 11 connected to the acquisition system 10. This electronic information processing unit 11 is a computer system of all types including computers, external peripherals (display unit, keyboards, etc.), programs, databases, etc. This information processing unit 11 is connected to the production ECU 7 in order to receive, if necessary from the production ECU, time information for associating the containers 2, their images and their detected defects with the mold number or with the forming cavity. Typically, the operation of the image acquisition system 10 is synchronized with the operation of the container forming cavities. Moreover, this information processing unit 11 transmits to the production ECU 7, the defects identified and the measurements performed, so that the production ECU can automatically deduce adjustment information for at least one control parameter of the manufacturing facility 3. Such adjustment of the control parameters is carried out manually or automatically. Finally, the information processing unit 11 is connected to an ejector to control the ejection of containers identified as defective, and/or to a display unit to present to an operator the identified defects, the transmission images and the infrared radiation images of the containers.

The acquisition system 10 makes it possible to observe each container 2, in two modalities, namely the infrared emission of a hot container and the transmission of a light passing through the same container. The system 10 for acquiring transmission images of the containers and infrared radiation images of the containers can be made in any appropriate manner. According to the example illustrated in FIG. 1, the acquisition system 10 includes on the one hand, a camera 13 sensitive to the infrared radiation emitted by the containers 2 and provided with a lens 13a and on the other hand, a source 14 of a light passing through the containers and a camera 15 sensitive to the light transmitted by the containers and provided with a lens 15a.

According to one advantageous characteristic of embodiment, the acquisition system 10 includes a system for selecting the light emitted by the light source 14 and positioned to eliminate, from the radiation captured by the camera 13 sensitive to the infrared radiation, the light emitted by the source 14. In other words, the acquisition device 10 is configured so that the camera 13 sensitive to the infrared radiation only captures the infrared radiation from the inspected container. Of course, this aim can be achieved in different ways.

For example, the infrared radiation image of a container is acquired when the light source 14 is turned off. According to another exemplary implementation, the infrared radiation image is acquired in a direction of observation such that with the infrared radiation of the container, the light emitted by the light source 14 is not captured, as in the example illustrated in FIG. 1. According to another exemplary embodiment, the light source 14 does not radiate in the sensitivity spectrum of the sensor of the camera 13 sensitive to the infrared radiation. According to one characteristic of the invention, the emission spectrum of the light source 14 is in a wavelength range less than 0.8 μm, and the sensor of the camera 13 sensitive to the infrared radiation captures the infrared radiation in a wavelength range greater than 0.8 μm.

The acquisition system 10 can also include optical filters so that the camera 13 sensitive to the infrared radiation only captures the infrared radiation from the inspected container. These optical filters can be mounted in any location between the light source 14 and the camera 13 sensitive to the infrared radiation.

FIG. 2 illustrates another exemplary embodiment in which the acquisition system 10 includes the light source 14 illuminating the containers 2, a sensor 13b sensitive to the infrared radiation emitted by the containers 2 and a sensor 15b sensitive to the light emitted by the light source 14 and transmitted by the containers. The acquisition system 10 also includes a common optical lens 18 for recovering the infrared radiation emitted by the containers and the light transmitted by the containers. This optical lens 18 is associated with an optical separation and filtration system 19 to eliminate the light emitted by the light source 14, from the radiation received by the sensor 13b sensitive to the infrared radiation.

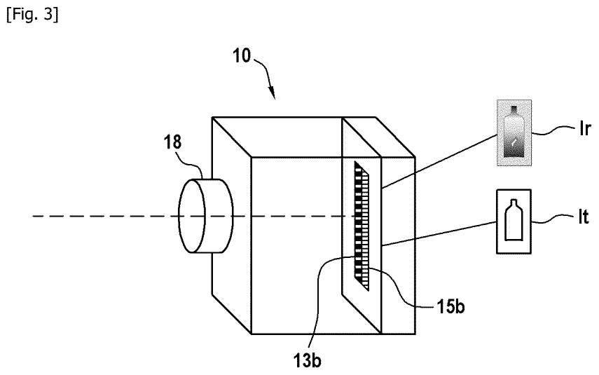

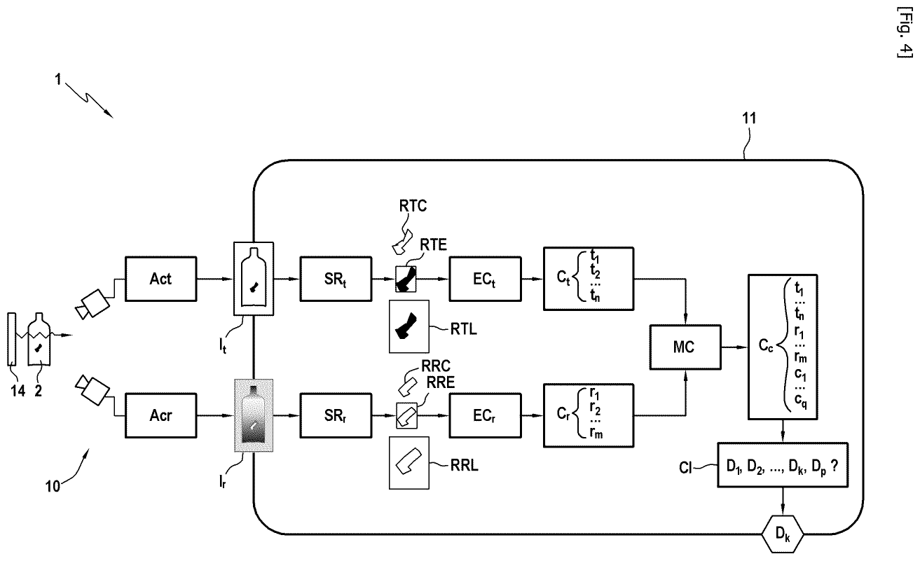

FIG. 3 illustrates another variant of embodiment of the acquisition system 10 including a camera with a common lens 18 for recovering the infrared radiation emitted by the containers and the light transmitted by the containers. The acquisition system 10 also includes two juxtaposed linear sensors, located in the focal plane of the camera, one of the sensors 13b being sensitive to the infrared radiation while the other sensor 15b is sensitive to the light emitted by the source 14. The linear sensors 13b, 15b are disposed in alignment with the axis of symmetry of the containers, that is to say vertically. Of course, the acquisition system 10 also includes a system for selecting the light emitted by the light source 14 and positioned to eliminate, from the radiation captured by the sensor 13b sensitive to the infrared radiation, the light emitted by the source 14.

The acquisition system 10 takes for each container 2, one or more transmission images It and infrared radiation images Ir, each of these images being two-dimensional. The acquired images are processed by the information processing unit 11 configured to include:
a system for analyzing at least one transmission image It and at least one infrared radiation image Ir,
a system for matching at least one region of an transmission image and at least one region of at least one infrared radiation image,
a classifier of the container, from at least one region of at least one transmission image and at least one region of at least one infrared radiation image, matched with each other, in order to identify for a container, at least one type of defects.

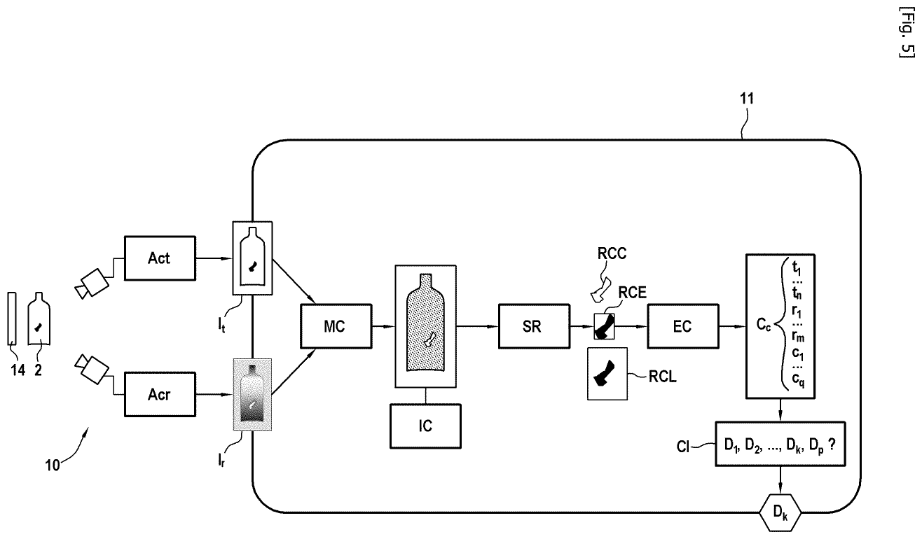

The information processing unit 11 is thus adapted to implement an inspection method to detect defects on containers while ensuring the identification, for a container, of one type of defects among a family of defects. As shown in FIGS. 4 to 9, the inspection method according to the invention consists, for each container, in implementing an operation Act of acquiring at least one transmission image It of the container 2 illuminated by the source 14 of a light passing through the container and an operation Acr of acquiring at least one infrared radiation image of the container. Of course, this image acquisition operation can concern all of the containers or only part of the containers.

The method according to the invention then consists in implementing operations of analyzing at least one transmission image and at least one infrared radiation image. The method according to the invention then consists in ensuring an operation or step of matching MC at least part of the transmission image It and at least part of the infrared radiation image Ir. The method then consists in implementing a classification step Cl, from the information contained in at least one transmission image and in at least one infrared radiation image, matched with each other, in order to identify for a container, at least one type of defects Dk.

According to a first embodiment implemented in the exemplary embodiments of FIGS. 4 to 7, the analysis operations aim to process the images so as to extract, in case of presence of a visible feature or an object, a region corresponding to this object. An object of a digital image is generally a set of related pixels having a common property that the neighboring sets do not have. An object is therefore surrounded by a closed contour and is recognized as such only based on properties of the images: gray level, etc.

An object corresponds to an area or region of an image potentially presenting a defect. A region with an object, also called candidate region, presents an object that can be classified as belonging to a class of objects among a list of possible classes including in particular types of defects. The list of the classes of objects is for example as follows:
mark of the container forming mold joint, shadow, decoration, coat of arms, code, which are not defects;
fold, river, lap mark, orange peel or crevasse which are surface defects;
fin, trapezoid, corked neck, which are shape defects;
crack, inclusion, blister, stone, bubble, which are internal defects in the material;
thin spot which is a poor glass distribution area.

According to this more precise approach, the method according to the invention aims to classify each container into at least one class belonging to a family of classes in which some of the classes include types of defects.

According to the invention, the classification of the containers is carried out through the classification of their images or portions of transmission image It and infrared radiation image Ir. It should be noted that frequently, the same container carries several different defects. Obviously, according to the invention, a first region of the container can be classified as a function of a first portion of transmission image It and a first portion of infrared radiation image Ir corresponding to this first container portion, and also for the same container, a second region of the container can be classified as a function of a second portion of transmission image It and a second portion of infrared radiation image Ir corresponding to this second container portion.

According to the invention, the classification of the containers or the images or portions of images aims to secure the production and quickly correct an error in the method. This advantage is particularly significant in case of occurrence in the method of a critical defect called trapezoid or birdswing. This defect is a glass thread inside the container and connected by its ends to the internal wall. The most typical trapezoids are crossing right through, with a shape of a loose cord in an arc curved downward. This defect can break and lead to broken glass in the future bottled liquid. It presents a danger to the consumer. Consequently, it is considered critical and must absolutely not be delivered with a container carrying a trapezoid. This filtering is successfully carried out by the cold or hot, visible or infrared inspections. On the other hand, in order to react to the manufacturing method, it is necessary to detect the defect, preferably under hot conditions, and to recognize it. However, if this defect is detected because it presents a feature in the images, it turns out that it is very polymorphic: sometimes the thread is absent and only one or both attachments is/are seen, sometimes it does not have the typical arch shape, etc. According to the invention, thanks to the classification based on the two images of the modalities in transmission and of infrared radiation, it is possible to recognize the trapezoids because at least one transmission image (generally two of them are made according to different angles of observation) accurately reveals the birdcage shape of the defect at the attachments while the image in infrared radiation informs that there is excess glass. Indeed, it is preferred to use infrared radiation passing through the glass and sensitive to the thickness. It is therefore immediately possible to inform an operator who acts and/or acts automatically on the manufacturing method, for example by correcting the blank temperature or the movement of the reverser. According to the invention, the trapezoid is therefore part of the list of possible classes of objects.

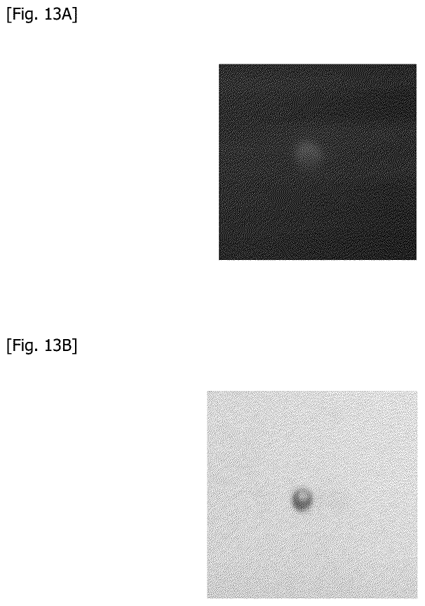

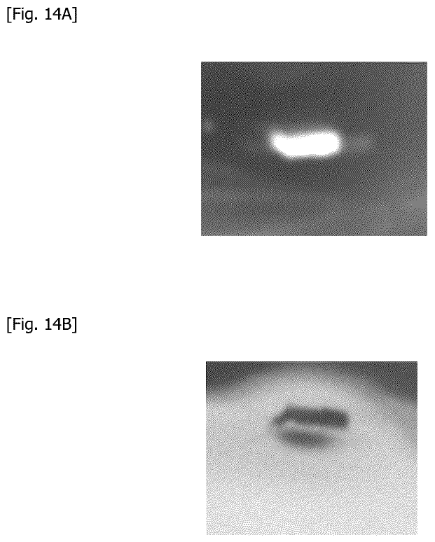

Another illustration of the advantage in the identification by classification of the defects is that the small inclusions, in particular of ceramics, are often confused in only one of the observation modalities with the small air bubbles. This confusion is inconvenient because these defects do not have the same seriousness and the same cause in the manufacturing method. As will be seen later in FIGS. 12A-12B and 13A-13B, the classification based on the images according to the two transmission and infrared radiation modalities, makes it possible to distinguish them and therefore to act correctly on the method, for example in the case of air or steam bubbles, to improve the refining of glass or the lubrication of the scissors and conduits called “delivery conduits”.

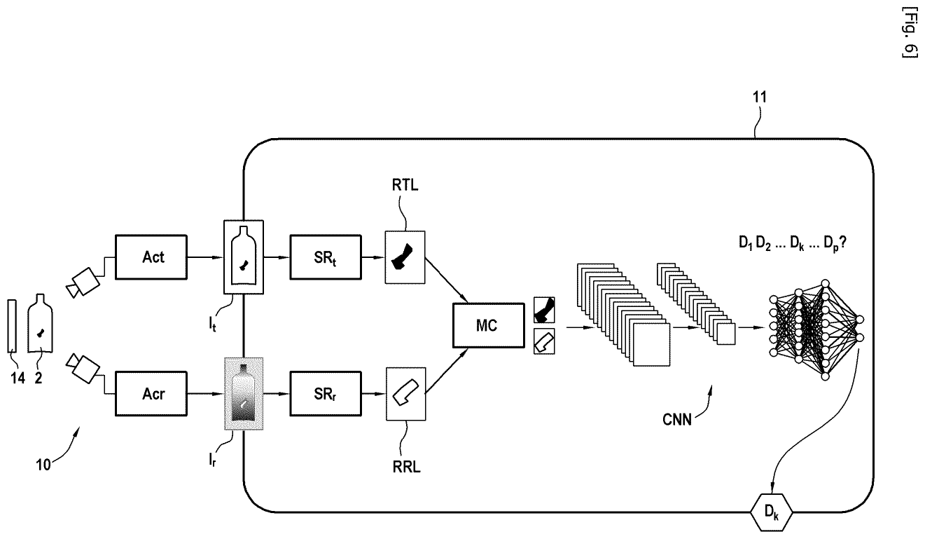

The operations of analyzing the transmission images It and the digital infrared radiation images Ir implement operations known per se, in particular filtering and segmentation operations carried out so as to extract all the regions with an object. Thus, the method implements an operation SRt of segmenting and detecting candidate regions on the transmission images It and an operation SRr of segmenting and detecting candidate regions on the infrared radiation images Ir (FIGS. 4, 6 and 7). According to the exemplary embodiment illustrated in FIG. 5, an operation SR of segmenting and detecting candidate regions is carried out on a composite image of an transmission image It and an infrared radiation image Ir as will be explained in the following description.

A segmentation operation traditionally consists in cutting the image into regions or segments, that is to say assigning to the pixels a belonging to a region. This segmentation operation aims to determine the candidate regions in each image, through filtering, thresholding, contour tracking operations, etc. for generally but not necessarily measuring parameters that characterize these regions. This image segmentation operation is carried out according to a filtering method adapted to the modality that is to say to the transmission images It and to the infrared radiation images Ir.

These segmentation operations SRt, SRr, SR make it possible to detect candidate image regions defined by their contour limited to the object, these candidate image regions RTC, RRC and RCC being respectively in transmission, in infrared radiation or these composites image regions being in transmission and infrared radiation. It is also possible that these segmentation operations SRt, SRr, SR make it possible to detect candidate image regions defined by its rectangle framing the object RTE, RRE, RCE, these candidate image regions being respectively in transmission and infrared radiation or these composite image regions being in transmission and infrared radiation. It is also possible that these segmentation operations SRt, SRr, SR make it possible to detect candidate image regions defined by its enlarged rectangle framing the object RTL, RRL, RCL, so as to take into account the context of the object, these candidate image regions being respectively in transmission, in infrared radiation or these composite image regions being in transmission and infrared radiation.

The method according to the invention implements an MC operation of matching the candidate regions of the transmission images or the candidate regions of the infrared radiation images with the corresponding regions respectively of the infrared radiation images and the transmission images, depending on their position on the container. This matching can also concern the candidate regions of the transmission images with the candidate regions of the infrared radiation images.

This MC matching operation aims to ensure a matching of the regions in the two images by comparing their respective positions on the container. In the most general case, a geometric transformation is determined from one image to another, which makes it possible, starting from a region or a pixel of a container image, to locate a region or a pixel of the other image corresponding to the same region or elementary part of the container. The geometric transformation is of any type necessary and includes for example, a translation/rotation, an anamorphosis, a change of scale, etc.

According to one variant of embodiment, two images or image regions of a container are pixel-to-pixel matched. To do so, the geometric transformation is determined for all the pixels. It is also possible to calculate for one of the two images, or image portion, a transformed image which can be superimposed on the other image or image portion. The geometric transformation and interpolations, for example bilinear interpolations, of the pixel values are then applied to all the pixels of the region concerned.

In the case where the transmission images and the images in infrared radiation match pixel to pixel due to the image acquisition system 10, the matching is direct. In this case, the acquisition device must be built very precisely so that the sensors of the cameras have the same field, magnification, direction of observation and resolution in pixels per mm, so that the matching is already carried out because the pixels of each transmission image and of infrared radiation correspond to the same elementary surface portion of the container. Of course any deviation from this ideal situation can be compensated by a matching using a suitable geometric transformation.

According to another variant of embodiment, regions whose middle or center of gravity are close on the container that is to say match or are neighboring each other by the geometric transformation are matched. Or regions whose rectangles framing the object RTE, RRE, RCE or enlarged rectangles framing the object RTL, RRL, RCL intersect or overlap on the container in a certain proportion of a given surface are matched.

Also, this MC matching can be carried out either from candidate regions to candidate regions or from pixel to pixel as in the illustrated exemplary embodiment.

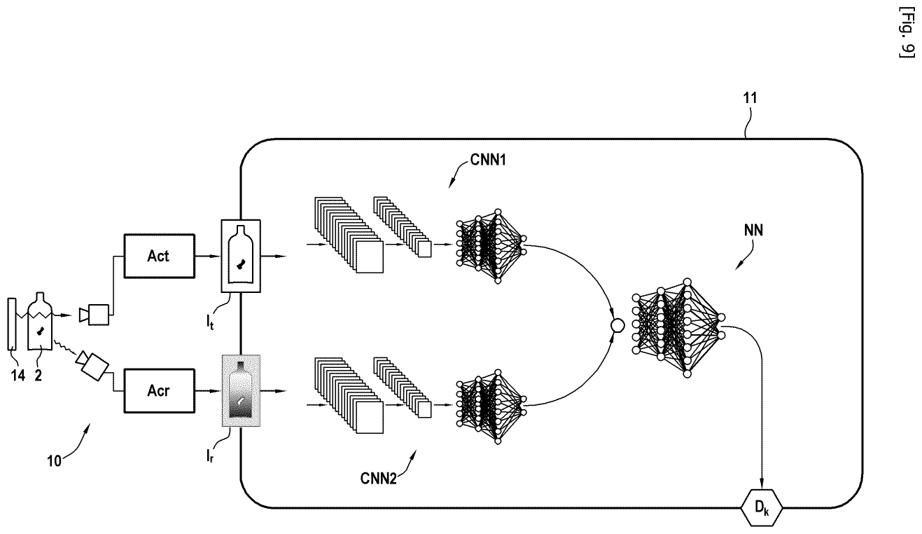

According to the exemplary embodiments illustrated in FIGS. 5 and 8, a composite image IC is made with matching of an image or image portion in transmission It and an image or image portion in radiation Ir. The method thus ensures, as a matching, a fusion of the transmission images and the infrared radiation images to obtain the composite image IC. The MC matching operation can concern all of the transmission images and in infrared radiation or only parts of these images. This MC matching is done pixel by pixel as explained previously. To each pixel pc(x,y) with coordinates x, y of the composite image is assigned a value which depends on the transmission obtained from the transmission image It and on the infrared radiation obtained from the image in radiation Ir. This value is for example either a 16-bit scalar pc(x,y) with 8 transmission bits and 8 infrared radiation bits or a vector vc(x,y) whose components {vt(x,y), vr(x,y)} are each a scalar in transmission and a scalar in infrared radiation. The simplest consists in directly reading the value of a pixel of the transmission image It and of a matched pixel of the image in radiation Ir. However, it is possible to construct each composite pixel from a combination of several neighboring pixels in the images, or interpolated values.

According to the exemplary embodiments illustrated in FIGS. 4, 6 and 7, the matching is carried out from candidate regions to candidate regions. It is possible to perform a registration from one image to the other in order to make the candidate regions coincide on the two different modality images. It is also possible to directly search for the candidate regions located in the same area of the container.

The method according to the invention aims to determine classification criteria in radiation and in transmission, which comprise criteria in transmission which take into account the characteristics ti (in number n) of the transmission images and criteria in infrared radiation which take into account the characteristics ri (in number m) of the infrared radiation images, and/or composite criteria which take into account characteristics ci (in number q) combining in a logical or mathematical manner transmission images and infrared radiation images. These characteristics are for example position, size, shape (concavity, perimeter, surface, etc.) or photometry (average level, contrast, variance, textures, etc.) characteristics.

According to the exemplary embodiments illustrated in FIGS. 4 and 5, the method according to the invention implements an operation ECt, ECr, EC of extracting the classification criteria. According to the exemplary embodiment illustrated in FIG. 4, the method implements an operation ECt of extracting the classification criteria for the candidate region RTC, RTE, RTL of the transmission images making it possible to define a vector Ct of dimension n representing n characteristics ti obtained from the image in radiation It for each candidate region. Likewise, the method according to the invention implements an operation ECr of extracting the classification criteria for the candidate region RRC, RRE, RRL from the images in infrared radiation making it possible to define a vector Cr of dimension m representing m characteristics ri obtained from the image in radiation Ir for each candidate region.

It should be noted that according to the exemplary embodiment illustrated in FIG. 4, the matching operation MC of the candidate regions RTC, RTE, RTL of the transmission images with candidate regions RRC, RRE, RRL of the images in infrared radiation makes it possible to obtain a vector Cc of dimension n+m+q representing n+m+q characteristics ti, ri and ci obtained for each candidate region matched between the transmission images and the images in infrared radiation.

In the exemplary embodiment illustrated in FIG. 5, the method according to the invention implements an operation EC of extracting the classification criteria in transmission and radiation for the composite candidate region in transmission and infrared radiation RCC, RCE or RCL, obtained after the segmentation operation SR. This extraction operation makes it possible to obtain a vector Cc of dimension n+m+q representing n+m+q characteristics ti, ri and ci obtained for each candidate region matched between the transmission images and the images in infrared radiation.

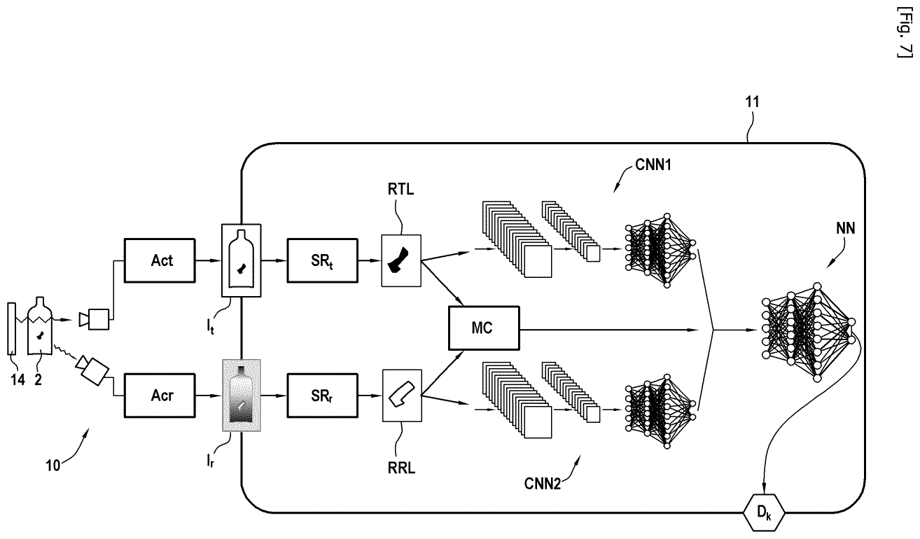

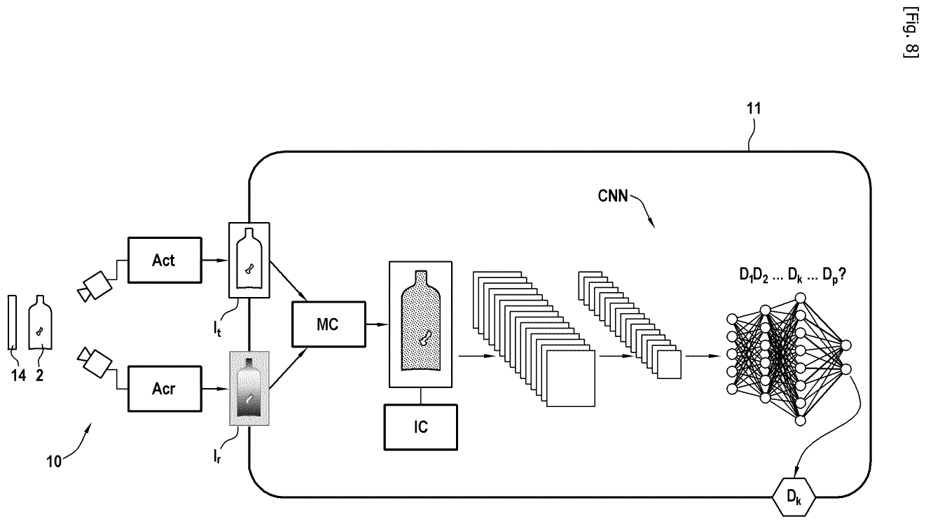

In the exemplary embodiments of FIGS. 4 and 5, the classification criteria are determined by a preliminary analysis, namely business knowledge or statistical studies. Image analysis algorithms determine the position, size, shape and photometry characteristics ti, ri, ci. In the exemplary embodiments illustrated in FIGS. 6 and 7, the classification criteria are determined by supervised learning by being buried in trained neural networks CNN, CNN1, CNN2. The learning set contains pairs of candidate regions (RTC, RRC), (RTE, RRE), (RTL, RRL) according to the two inspection modalities, with as label, a class of objects among a list of possible classes such as defect types.

Using the previously determined classification criteria in transmission and in radiation, the method classifies the defects and consequently, the containers carrying these defects. The classification operation makes it possible to decide on the class of objects Dk of the candidate region or of the container among p possible classes D1, D2, . . . Dp. If a candidate region is found in only one of the two images according to a first modality, an analysis of the defect according to the criteria associated with the type of image used is carried out but also criteria associated with the other modality are taken into account: an analysis based on the fusion of the criteria associated with the two types of images is performed. The principle of the invention is based on taking into account the two inspection modalities to provide additional and reliable information to make the decision to classify objects or containers, and therefore the identification of the defects.

The classification decision gives a belonging class Dk of the container among p possible classes. The p classes are mainly the types of defects and concern in particular the bubbles, folds, rivers, lap marks, orange peel, crevices, fins, trapezoids, corked necks, blisters, stones, mold joint marks, shadows, decorations, coats of arms, codes, thin spots, etc. Several classes can be provided for the same defect if this defect has varied shapes such as for example trapezoid 1 and trapezoid 2. According to one preferred exemplary implementation, the object of the invention aims to classify each container according to at least one class of objects among a list of possible classes containing at least types of defects, the list of possible classes including at least: non-defect, trapezoid, inclusion and bubble.

In the exemplary embodiments illustrated in FIGS. 4 and 5, the classifier Cl can be for example a support vector machine (SVM), a Bayesian classifier or a neural network NN. The classifier Cl carries out the classification using the classification criteria in transmission and in radiation previously determined. The classifier Cl is trained by supervised learning methods consisting in determining parameters of the classifier from a set of objects or images whose class is known, called learning set, and generally also a test set. The learning set comprises pairs of regions, preferably pairs of characteristic vectors Ct, Cr associated with a type of defect, namely {Ct, Cr, Dk}. Typically, the supervised learning classifier is trained by a learning database consisting of a set of records each including for each observed exemplary container:
at least one radiation image of the container, at least one transmission image of the container and at least one label assigning to the exemplary container at least one class of objects among a list of possible classes such as types of defects, or
at least one radiation image region of the exemplary container, at least one image region in transmission of the exemplary container and at least one label assigning to the corresponding region of the exemplary container at least one belonging class among a list of classes of objects such as types of defects.

According to the exemplary embodiment illustrated in FIG. 6, the classifier is a Convolutional Neural Network CNN having as input data, a pair of candidate regions (RTC, RRC), (RTE, RRE) or (RTL, RRL), obtained after the matching operation MC.

According to the exemplary embodiment illustrated in FIG. 7, the classifier includes a first Convolutional Neural Network CNN1 having as input data, a candidate region in transmission (RTC, RTE, RTL) obtained after the operation SRt of segmenting and detecting candidate regions on the transmission images It. The classifier also includes a second Convolutional Neural Network CNN2 having as input data, a candidate region in infrared radiation (RRC, RRE, RRL) obtained after the operation SRr of segmenting and detecting candidate regions on the images in infrared radiation Ir. The first Convolutional Neural Network CNN1 and the second Convolutional Neural Network CNN2 each work in parallel respectively on a candidate region in transmission (RTC, RTE, RTL) and on a candidate region in infrared radiation (RRC, RRE, RRL), these two regions according to the two modalities, being associated by the matching operation MC according to the techniques explained above.

The outputs of the first Convolutional Neural Network CNN1 and of the second Convolutional Neural Network CNN2 are the input data of a classifier, for example of the SVM, Random Forest, Bayesian type, and preferably a neural network NN, allowing classification according to the two modalities. The outputs of the first Convolutional Neural Network CNN1 and of the second Convolutional Neural Network CNN2 are for example assumptions of belonging classes but they can be more complex data with vectors of dimensions greater than the number p of classes. The learning set of the neural networks contains pairs of candidate regions (RTC, RRC), (RTE, RRE), (RTL, RRL) according to the two inspection modalities, with as a label, a class of objects among a list of possible classes such as types of defects.

According to a second embodiment implemented in the exemplary embodiments of FIGS. 8 and 9, the operations of analyzing the images do not aim to extract therefrom a candidate region but to take into account all or part of the transmission images It and infrared radiation images Ir, without the implementation of a prior segmentation operation. According to these two exemplary embodiments, the analysis operations are based on the implementation of neural networks. If only parts of images are analyzed, these parts preferably correspond to one or more regions of interest of the container such as the finish, the neck, the shoulder, the body, the chime or a right or left half-side or an area where engravings are present.

In the exemplary embodiment illustrated in FIG. 8, an operation MC of matching an transmission image It and an image in radiation Ir is carried out in order to obtain a composite image IC. The composite image IC is obtained by fusion of at least one radiation image with at least one transmission image of a container or by fusion of regions of at least one image in radiation with corresponding regions of at least one transmission image.

The transmission image It and the image in radiation Ir are taken during the acquisition operations Act, Acr carried out by the image acquisition system 10, as explained in the description above. This matching MC of the pixel to pixel images is carried out as explained in the exemplary embodiment of FIG. 5. This composite image IC is used as input data of a Convolutional Neural Network CNN which is able, through learning, to take into account the position, size, shape and photometry characteristics that are significant for the intended classification. The learning set contains composite images IC or composite image regions with as a label, a class of objects among a list of possible classes such as types of defects. The classification criteria in transmission and in radiation are taken into account in the weights resulting from the learning and defining the Convolutional Neural Network CNN. It should be noted that unlike the examples in FIGS. 5 and 6, the segmentation operation is not necessary in this variant because the stages of the Convolutional Neural Network are able, through learning, to classify the images according to their content without prior segmentation, and to locally determine the position, size, shape and photometric characteristics that are significant for the classification. But a segmentation operation is possible for example by replacing in FIG. 5 the extraction of characteristics EC and the classifier CL by a classifier based on a Convolutional Neural Network CNN.

In the exemplary embodiment illustrated in FIG. 9, the transmission image It (in whole or in part) taken by the image acquisition system 10, is used as input data of a first Convolutional Neural Network CNN1 which is able, through learning, to determine the position, size, shape and photometry characteristics which are significant for the provided classification. The infrared radiation image Ir (in whole or in part) taken by the image acquisition system 10, is used as input data of a second Convolutional Neural Network CNN2 which is able, through learning, to determine the position, size, shape and photometry characteristics that are significant for the intended classification.

The first Convolutional Neural Network CNN1 and the second Convolutional Neural Network CNN2 each work in parallel on two candidate images in each modality. The outputs of the first Convolutional Neural Network CNN1 and of the second Convolutional Neural Network CNN2 are the input data of a classifier, for example of the SVM, Random Forest, Bayesian type, and preferably a neural network NN, making it possible to classify the containers according to both modalities. It should be noted that the two candidate images in each modality on which the first Convolutional Neural Network CNN1 and the second Convolutional Neural Network CNN2 work are associated with a matching operation.

The outputs of the first Convolutional Neural Network CNN1 and of the second Convolutional Neural Network CNN2 are for example assumptions of belonging classes but it can be more complex data with vectors of dimensions greater than the number p of classes. The learning set of the neural network contains pairs of images according to the two inspection modalities, with as a label a class of objects among a list of possible classes such as types of defects. The classification criteria in transmission and in radiation are taken into account in the weights resulting from the learning and defining the neural networks CNN1, CNN2 and NN. It should be noted that unlike the example in FIG. 7, the segmentation operation is not necessary in this variant because the steps of the Convolutional Neural Network are able, through learning, to classify the images according to their content without prior segmentation, and to locally determine the position, size, shape and photometry characteristics which are significant for the classification.

The object of the invention is advantageously used within the framework of the manufacturing facilities to allow better detection and categorization of the defects present within containers formed while still hot. Some defects can be seen, detected and categorized more easily according to one of the two modalities or thanks to the combination of the two modalities.

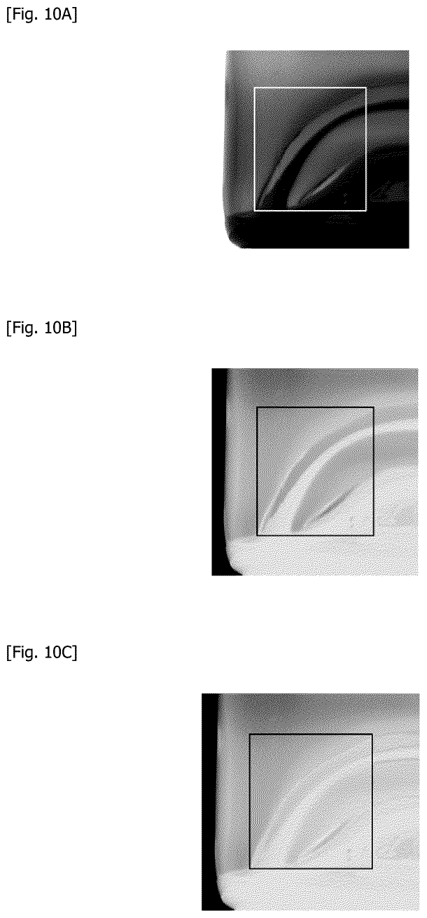

FIG. 10A is a simulated image of a defect seen in transmission, at the level of the pit of a container while FIGS. 10B and 10C are simulated images of the same defect seen in infrared radiation, if it is respectively a filled cavity or a stuck glass. This defect gives the impression of a trapezoid included in a less absorbent cavity. As if an air bubble had been formed between the pit and its top, leaving only a glass thread. It could also be another piece of glass, stuck on the wall of the container, or caught on the pit inside the container. An infrared image would potentially confirm or not the presence of a glass thread which emits more, and of an air bubble which emits less.

In the case of a strong change in contrast for the transmission modality and of a strong change in contrast for the infrared radiation modality, it can be concluded that it is an accumulation of material at this location corresponding to a trapezoid, contained in an air bubble (FIG. 10B). In the case of a strong change in contrast for the transmission modality and of a weak change in contrast for the infrared radiation modality, it is two pieces of glass stuck at the level of the pit (FIG. 10C).

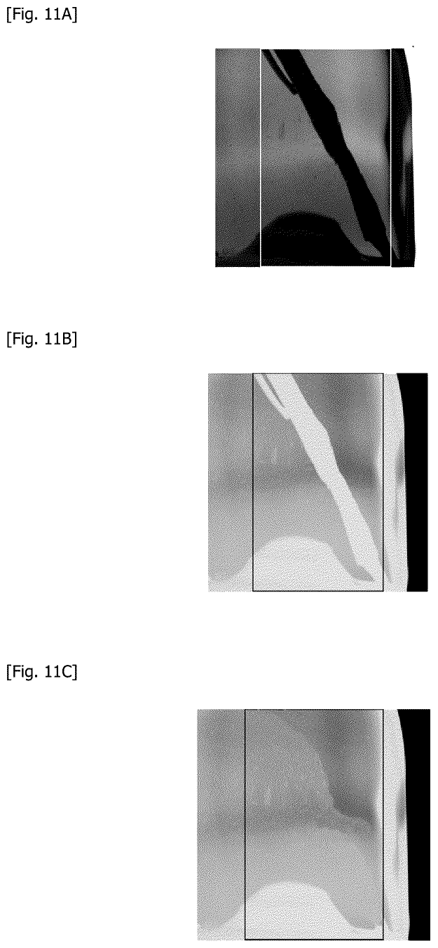

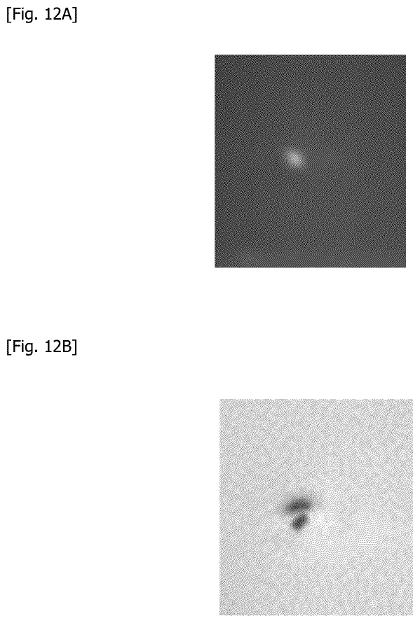

FIG. 11A is an image of a defect seen in transmission while FIGS. 11B and 11C are simulated images of the same defect seen in infrared radiation if it is respectively a piece of glass or a grease stain. It could be a critical defect, namely a trapezoid, that is to say a piece of glass contained in the container. But it could also be a trace of grease, namely a superficial defect, visible on the wall of the container. If it is a thick piece of glass, contained inside the container, its infrared radiation will be added to that of the walls of the container and increase in intensity. Conversely, if it is a simple grease stain, there should not be a big difference between the infrared radiation of the container wall and that of a superficial defect.

In the case of a strong change in contrast for the transmission modality and of a strong change in contrast for the infrared radiation modality, it is an accumulation of material at this location corresponding to a trapezoid (FIG. 11B). In the case of a strong change in contrast for the transmission modality and a weak change in contrast for the infrared radiation modality, it is a defect absorbing the visible light, probably a grease stain at the level of the surface of the container (FIG. 11C).

FIGS. 12A, 13A and 14A are real images obtained with an infrared camera of InGaAs technology, while FIGS. 12B, 13B and 14B are real images of the same defects seen in transmission, the acquisitions of the container images having been carried out at the output of a manufacturing machine in a manufacturing factory where cameras according to the inspection device according to the invention are installed.

FIG. 12A is an image of a defect seen in infrared radiation while FIG. 12B is an image of the same defect seen in transmission. According to the prior art, the defect observed on the transmission image of FIG. 12B leads to uncertainty as to its belonging class between a stone and a blister. According to the invention, the image in infrared radiation shows a defect which has infrared radiation corresponding to the presence of glass making it possible to clear up some confusion and conclude to the presence of a stone.

FIG. 13A is an image of a defect seen in infrared radiation while FIG. 13B is an image of the same defect seen in transmission. The defect in the transmission image suggests a stone or blister defect. However, it is seen in the image in infrared radiation that the defect emits little and is less contrasted than in FIG. 12A. The defect is therefore a blister.

FIG. 14A is an image of a defect seen in infrared radiation while FIG. 14B is an image of the same defect seen in transmission. The defect in the transmission image suggests a blister defect due to the clear transition in the center of the black stain. However, it is seen on the image in infrared radiation that the entire defect radiates so that the defect is a stone.

These different examples show the advantage in the object of the invention in using two inspection modalities to improve both the detection and the classification of the defects. The second inspection modality makes it possible to confirm the classification of the defect, carried out using the first modality, or to invalidate it by allowing the classification of the defect in another class. For defects that are barely visible in one modality, an image according to the other modality provides additional information to correctly classify the defects.

It may happen that the signal of a defect is weak according to the two modalities considered. It should be noted that the transformation into a composite image can reveal objects that were too weakly contrasted in the two modalities, but which, once the fusion is performed, become easier to spot.

The invention applies to any method for manufacturing glass containers, including bottles, pots, vials, syringes, bulbs, table glasses, jars, plates. Indeed, in all these manufacturing methods, there is after forming, a long step of cooling the glass objects, and the inspection and recognition of the defects as soon as possible is useful.

1. A method for inspecting still hot glass containers exiting a manufacturing facility, for identifying, for a container, a type of one or more defects, the method comprising: for each container,
acquiring at least one transmission image (It) of the container illuminated by a source of a light passing through the container and at least one infrared radiation image (Ir) of the container,
analyzing said at least one transmission image and said at least one infrared radiation image,
ensuring a matching of at least part of the transmission image and at least part of the infrared radiation image,
classifying the container, from said at least one transmission image and said at least one infrared radiation image, matched with each other, in order to identify, at least one type of defects.

2. The inspection method according to claim 1 according to which the container is illuminated by a light source of which emission spectrum is in a wavelength range less than 0.8 μm, and the infrared radiation image of a container in a wavelength range greater than 0.8 μm is acquired.

3. The inspection method according to claim 1 according to which the infrared radiation image of a container is acquired when the light source is turned off.

4. The inspection method according to claim 1 according to which the infrared radiation image is acquired in a direction of observation such that the light emitted by the light source is not captured with the infrared radiation of the container.

5. The inspection method according to claim 1 according to which, to ensure the matching of the transmission images and the infrared radiation images, the method detects candidate regions in the transmission images and in the infrared radiation images, the method ensuring, for each container:
a matching of the candidate regions (RTC, RTE, RTL) of the transmission images or the candidate regions of the infrared radiation images (RRC, RRE, RRL) with the corresponding regions respectively of the infrared radiation images and the transmission images, as a function of their position on the container, or
a matching of the candidate regions of the transmission images with the candidate regions of the infrared radiation images.

6. The inspection method according to claim 5 according to which the method ensures, as a matching, a fusion of the transmission images and the infrared radiation images to obtain a composite image (IC), the method ensuring:
an extraction of classification characteristics from the composite image, expressing classification criteria in transmission and in radiation, and
a classification of the container using the classification criteria in transmission and in radiation.

7. The inspection method according to claim 1 according to which the method ensures, as a matching, a fusion of the transmission images and the infrared radiation images to obtain a composite image, the method ensuring:
a segmentation of the composite images to detect composite candidate regions,
an extraction of classification characteristics from the composite candidate regions, expressing classification criteria in transmission and in radiation,
a classification of the container using the classification criteria in transmission and in radiation of the composite candidate regions.

8. The inspection method according to claim 1 according to which:
classification criteria in transmission are extracted from the transmission images,
classification criteria in radiation are extracted from the infrared radiation images,
the container is classified using the classification criteria in transmission and in radiation.

9. The inspection method according to claim 8 according to which classification criteria in radiation are chosen for the infrared radiation images and classification criteria in transmission are chosen for the transmission images, and/or composite criteria which take into account characteristics combining in a logical or mathematical manner transmission images and infrared radiation images are chosen, these classification criteria in radiation and in transmission being position, size, shape or photometry criteria.

10. The inspection method according to claim 1 consisting in classifying the container by a supervised learning classifier whose input data are:
the classification criteria in radiation and in transmission,
or the radiation images and the transmission images,
or parts of the images in radiation and parts of the transmission images.

11. The inspection method according to claim 1 consisting in classifying the container by a supervised learning classifier whose input data are at least one composite image (IC) obtained by fusion of at least one radiation image with at least one transmission image of a container or by fusion of regions of at least one image in radiation with corresponding regions of at least one transmission image.

12. The inspection method according to claim 10 consisting in classifying the container by a supervised learning classifier trained by a learning database consisting of a set of records each including for an observed exemplary container:
at least one radiation image of the container, at least one transmission image of the container and at least one label assigning to the exemplary container at least one class of objects among a list of possible classes such as types of defects, or
at least one radiation image region of the exemplary container, at least one image region in transmission of the exemplary container and at least one label assigning to the corresponding region of the exemplary container at least one class of objects among a list of possible classes such as types of defects.

13. The inspection method according to claim 1 according to which each container is to be classified according to at least one class of objects among a list of possible classes containing at least types of defects, the list of possible classes including at least: no defect, trapezoid, inclusion, bubble.

14. The inspection method according to claim 1 according to which a step of taking into account at least one type of detected defect is implemented to deduce adjustment information for at least one control parameter of the manufacturing facility.

15. A device for inspecting still hot glass containers exiting a manufacturing facility for identifying, for a container, a type of defects, the device including:
a system for acquiring transmission images of the containers and infrared radiation images of the containers,
an information processing unit connected to the image acquisition system, this information processing unit being configured to include:
a system for analyzing at least one transmission image and at least one infrared radiation image of the container,
a system for matching at least one region of an transmission image and at least one region of at least one infrared radiation image of the container,
a classifier of the container, based on at least one region of at least one transmission image and at least one region of at least one infrared radiation image, matched with each other, in order to identify for a container, at least one type of defect.

16. The device according to claim 15 according to which the system for acquiring transmission images of the containers and infrared radiation images of the containers includes on the one hand, a camera sensitive to the infrared radiation emitted by the containers and provided with a lens and on the other hand, a source of light passing through the containers and a camera sensitive to the light transmitted by the containers and provided with a lens.

17. The device according to claim 15 according to which the image acquisition system includes a system for selecting the light emitted by the light source and positioned to eliminate, from the radiation captured by the camera sensitive to the infrared radiation, the light emitted by the light source.

18. The device according to claim 15 according to which the system for acquiring transmission images of the containers and infrared radiation images of the containers includes:
a light source illuminating the containers,
a sensor sensitive to the infrared radiation emitted by the containers,
a sensor sensitive to the light emitted by the light source and transmitted by the containers,
a common optical lens for recovering the infrared radiation emitted by the containers and the light transmitted by the containers, this optical lens being associated with an optical separation and filtration system to eliminate the light emitted by the light source, from the radiation received by the sensor sensitive to the infrared radiation.

19. The device according to claim 15 according to which the information processing unit is connected:
to an ejector for controlling the ejection of containers identified as defective, and/or
a display unit for presenting to an operator the identified defects, the transmission images and the infrared radiation images of the containers.

20. The device according to claim 15 according to which the information processing unit is connected to a production ECU supervising the manufacturing facility in order to:
receive from the production ECU, time information allowing the containers, their images and their detected defects to be associated with the mold number or with the forming cavity, and
transmit to the production ECU the defects identified and measurements performed, so that the production ECU can automatically deduce adjustment information for at least one control parameter of the manufacturing facility.
